(19) United States
(12) Patent Application Publication
(10) Pub. No.: US 2021/0188254 A1
(43) Pub. Date: Jun. 24, 2021

(54) ELECTRIC VEHICLE AND CONTROL METHOD FOR ELECTRIC VEHICLE

(71) Applicant: TOYOTA JIDOSHA KABUSHIKI KAISHA, Toyota-shi (JP)

(72) Inventor: Suguru KUMAZAWA, Nisshin-shi (JP)

(73) Assignee: TOYOTA JIDOSHA KABUSHIKI KAISHA, Toyota-shi (JP)

(21) Appl. No.: 17/072,019

(22) Filed: Oct. 15, 2020

(30) Foreign Application Priority Data
Dec. 20, 2019 (JP) 2019-230083

(51) Int. Cl. B60W 30/06; B60K 1/00; B60K 1/04; B60L 15/20; B60W 10/18; B60W 10/08

(52) U.S. Cl. CPC B60W 30/06; B60K 1/00; B60W 10/08; B60L 15/20; B60W 10/18; B60K 1/04

(57) ABSTRACT

An ECU executes a process including a step of setting an upper limit value in a case where a gear shift position is a traveling position, a vehicle is stopped, the vehicle is in a brake-on state, and a cancellation request flag is in an OFF state, and a step of canceling the setting of the upper limit value in a case where the cancellation request flag is in an ON state.

### CROSS-REFERENCE TO RELATED APPLICATION

This application claims priority to Japanese Patent Application No. 2019-230083 filed on Dec. 20, 2019, incorporated herein by reference in its entirety.

### BACKGROUND

### 1. Technical Field

The present disclosure relates to automatic parking control for an electric vehicle.

### 2. Description of Related Art

An electric vehicle including a parking assist device that assists a user's parking when parking the vehicle at a parking location is well-known. The parking assist device may adjust, for example, vehicle speed during executing automatic parking control by controlling driving force and braking force of the vehicle.

For such a parking assist device, International Publication No. 2018/230175 discloses a technology in which the vehicle speed is increased during parking according to behavior from previous parking (for example, elapsed time or travel distance), thereby reducing the discomfort felt by a driver familiar with using the automatic parking control.

### SUMMARY

When the electric vehicle is stopped, driving torque may be limited in order to prevent a drive motor from being overheated due to a large driving torque being generated in the drive motor, for example, in a state where the rotation of the wheels is limited by the braking device. However, if the driving torque is limited during executing of the automatic parking control, for example, the vehicle may fall backward on the slope due to insufficient driving torque on a slope, or parking may take a longer time.

The present disclosure is intended to address the shortcomings described above. An objective of the present disclosure is to provide an electric vehicle and a control method for an electric vehicle, which are respectively capable of promptly completing parking while preventing the vehicle from falling backward when executing automatic parking control.

An electric vehicle according to one aspect of the present disclosure includes a power storage device, a drive electric motor configured to apply driving torque to the electric vehicle using electric power of the power storage device, a braking device configured to operate by receiving hydraulic pressure, and a control device configured to limit the driving torque such that the driving torque does not exceed an upper limit value which is set such that the drive electric motor is not overheated, when the electric vehicle is stopped while the hydraulic pressure is supplied to the braking device. The control device is configured to, while executing automatic parking control for moving the electric vehicle toward a target location without an operation of a user, cancel limitation of the driving torque in a case where the driving torque is applied to the electric vehicle that has stopped.

Consequently, it is possible to prevent the vehicle from falling backward due to insufficient driving torque during the automatic parking control on the slope. Therefore, the parking can be promptly completed.

In the aspect, the control device may cancel, while executing the automatic parking control, the limitation of the driving torque until a predetermined period elapses in a case where the driving torque is applied to the electric vehicle that has stopped.

With this configuration, while automatic parking control is executed, the limitation of the driving torque is canceled until the predetermined period elapses in a case where the driving torque is applied to the electric vehicle that has stopped. Thus, it is possible to prevent the vehicle from falling backward due to insufficient driving torque during the automatic parking control, for example, on the slope. Therefore, the parking can be promptly completed.

Further, in the aspect, the control device may gradually change, while executing the automatic parking control, the driving torque such that the driving torque is equal to or less than the upper limit value in a case where the electric vehicle does not move until the predetermined period elapses.

Consequently, it is possible to prevent the electric vehicle from falling backward by gradually changing the driving torque in a case where the vehicle does not move while the automatic parking control is executed. Further, it is possible to prevent the drive electric motor from being overheated by reducing the driving torque such that the driving torque is equal to or less than the upper limit value.

Further, in the aspect, the control device may increase, while executing the automatic parking control, the driving torque and reduce the hydraulic pressure supplied to the braking device in a case where the driving torque is applied to the electric vehicle that has stopped.

Consequently, it is possible to promptly complete the parking while preventing the vehicle from falling backward, for example, on the slope.

A control method for an electric vehicle according to another aspect of the present disclosure is a control method for an electric vehicle. The electric vehicle includes a power storage device, a drive electric motor configured to apply driving torque to the electric vehicle using electric power of the power storage device, and a braking device configured to operate by receiving hydraulic pressure. The control method includes a step of limiting the driving torque such that the driving torque does not exceed an upper limit value which is set such that the drive electric motor is not overheated, when the electric vehicle is stopped while the hydraulic pressure is supplied to the braking device, and a step of canceling, while executing automatic parking control for moving the electric vehicle toward a target location without an operation of a use, limitation of the driving torque in a case where the driving torque is applied to the electric vehicle that has stopped.

With the present disclosure, it is possible to provide an electric vehicle and a control method for an electric vehicle, which are respectively capable of promptly completing parking while preventing the vehicle from falling backward when executing automatic parking control.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a configuration of an electric vehicle;

FIG. 2 is a diagram showing a part of functional blocks set in an ECU;

FIG. 3 is a flowchart showing one example of processing executed by an automatic parking control unit;

FIG. 4 is a flowchart showing one example of processing executed by an upper limit value setting unit;

FIG. 5 is a time chart showing one example of an operation of the ECU; and

FIG. 6 is a time chart showing another example of the operation of the ECU.

### DETAILED DESCRIPTION OF EMBODIMENTS

Hereinafter, embodiments of the present disclosure will be described in detail with reference to drawings. In the drawings, the same or equivalent components will have the same reference signs assigned, and descriptions thereof will be omitted.

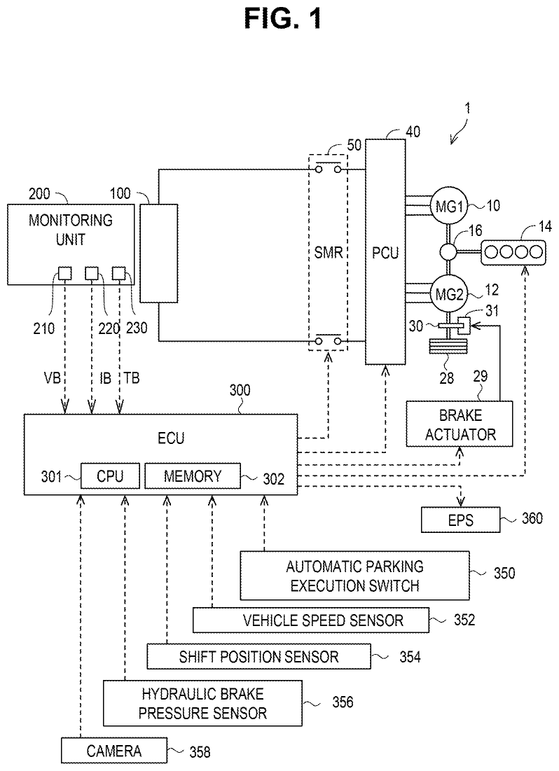

Hereinafter, a case where an electric vehicle according to an embodiment of the present disclosure is a hybrid vehicle will be described as one example. FIG. 1 is a diagram schematically illustrating a configuration of an electric vehicle 1 (hereinafter simply referred to as a “vehicle 1”). As shown in FIG. 1, the vehicle 1 includes a first motor generator (hereinafter referred to as a “first MG”) 10, a second motor generator (hereinafter referred to as a “second MG”) 12, an engine 14, a power split device 16, a drive wheel 28, a brake actuator 29, a braking device 31, a power control unit (PCU) 40, a system main relay (SMR) 50, a power storage device 100, a monitoring unit 200, an electronic control unit (ECU) 300, and an electric power steering (EPS) 360.

Each of the first MG 10 and the second MG 12 is a three-phase alternating current rotating electric motor, e.g., a permanent magnet synchronous motor including a rotor in which permanent magnets are embedded. Each of the first MG 10 and the second MG 12 functions as both an electric motor and a power generator. The first MG 10 and the second MG 12 are connected to the power storage device 100 via the PCU 40.

The first MG 10 may, for example, be driven by an inverter included in the PCU 40 when the engine 14 is started, and rotates an output shaft of the engine 14. Further, the first MG 10 receives the power of the engine 14 and generates power during power generation. The electric power generated by the first MG 10 is stored in the power storage device 100 via the PCU 40.

The second MG 12 may, for example, be driven by an inverter included in the PCU 40 when the vehicle 1 is traveling. The power of the second MG 12 is transmitted to the drive wheel 28 via a power transmission gear (not shown), such as a differential gear or a reduction gear. Further, the second MG 12 may, for example, be driven by the drive wheel 28 during braking, and the second MG 12 operates as the generator to perform regenerative braking. The electric power generated by the second MG 12 is stored in the power storage device 100 via the PCU 40. In the present embodiment, the second MG 12 corresponds to a “drive electric motor”. Even though only one drive wheel 28 is shown in FIG. 1, at least two drive wheels 28 are actually provided in the vehicle 1.

The engine 14 is a well-known internal combustion engine that burns fuel (gasoline or light oil), such as a gasoline engine or a diesel engine, so as to output power, and is configured such that operating states (such as a throttle opening degree (an intake amount), a fuel supply amount, and ignition timing) are electrically controlled by an ECU 300. The ECU 300 may control, for example, a fuel injection amount, ignition timing and an intake air amount of the engine 14 such that the engine 14 operates at a target rotation speed and a target torque set based on a state of the vehicle 1.

The power split device 16 splits the power of the engine 14 into a path transmitted to the drive wheel 28 and a path transmitted to the first MG 10. The power split device 16 may be configured by, for example, a planetary gear mechanism.

The braking device 31 is provided for each wheel (including the drive wheel 28), and is configured to generate a friction braking force on the wheel using a hydraulic pressure supplied from the brake actuator 29. The braking device 31 includes a disc rotor 31a and a brake caliper 31b. The disc rotor 31a is fixed to a wheel and is configured to be integrally rotatable with the wheel. The brake caliper 31b includes a wheel cylinder and a brake pad (neither shown). The wheel cylinder is operated by the hydraulic pressure supplied from the brake actuator 29. The brake pad is pressed against the disc rotor 31a to limit the rotation of the disc rotor 31a during operating the wheel cylinder. The higher the hydraulic pressure applied to the wheel cylinder is, the higher a pressing force of the brake pad against the disc rotor 31a is.

The brake actuator 29 is configured to supply the hydraulic pressure to each wheel cylinder of each wheel according to a control signal from the ECU 300. The brake actuator 29, for example, supplies the hydraulic pressure to the braking device 31 of each wheel regardless of an operation of a brake pedal, or supplies the hydraulic pressure, to the braking device 31 of each wheel, corresponding to a depression amount of the brake pedal.

The PCU 40 is a power conversion device that performs power conversion between the power storage device 100 and the first MG 10, or performs power conversion between the power storage device 100 and the second MG 12, according to the control signal from the ECU 300. The PCU 40 may include, for example, the inverter that converts direct current power from the power storage device 100 into alternating current power so as to drive the first MG 10 or the second MG 12, and a converter that adjusts a voltage level of the direct current power supplied from the power storage device 100 to the inverter (neither shown).

The SMR 50 is electrically connected between the power storage device 100 and the PCU 40. Closing/opening of the SMR 50 is controlled according to the control signal from the ECU 300.

The power storage device 100 is a rechargeable direct current power supply, and may be, for example, a secondary battery, such as a nickel-metal hydride battery or a lithium-ion battery containing a solid or liquid electrolyte. As the power storage device 100, a capacitor, such as an electric double layer capacitor, can also be employed. The power storage device 100 supplies the electric power for generating a travel driving force of the vehicle 1 to the PCU 40. In addition, the power storage device 100 is charged with the electric power generated by using the first MG 10 and the engine 14, charged with the electric power generated by the regenerative braking of the second MG 12, or discharged by a driving operation of the first MG 10 or the second MG 12.

The monitoring unit 200 includes a voltage detection unit 210, a current detection unit 220, and a temperature detection unit 230. The voltage detection unit 210 detects the voltage VB between terminals of the power storage device 100. The current detection unit 220 detects the current IB input to and output from the power storage device 100. The temperature detection unit 230 detects the temperature TB of the power storage device 100. Each detection unit outputs the detection result to the ECU 300.

The EPS 360 may include, for example, an electric actuator that applies a steering force to a steering wheel. The EPS 360 uses the electric actuator to assist the steering force generated by a user's steering operation, or applies the steering force to the steering wheel using the electric actuator regardless of the user's steering operation, according to the control signal from the ECU 300. The steering wheel may be the drive wheel 28, or may be another driven wheel provided in the vehicle 1.

The ECU 300 is an electronic control unit having a central processing unit (CPU) 301, and a memory (including, for example, a read-only memory (ROM) or a random access memory (RAM)) 302. The ECU 300 controls each device (the engine 14, the brake actuator 29, the PCU 40, the SMR 50 and the like) in the vehicle 1 such that the vehicle 1 is in a desired state based on a signal received from the monitoring unit 200, an automatic parking execution switch 350, a vehicle speed sensor 352, a shift position sensor 354 or a hydraulic brake pressure sensor 356, or information, such as maps or programs stored in the memory 302. Various controls executed by the ECU 300 are not limited to processing executed by software, and may be performed by dedicated hardware (an electronic circuit).

The ECU 300 may calculate, for example, a state-of-charge (SOC) indicating remaining capacity of the power storage device 100, while the vehicle 1 is operated, using the detection result of the monitoring unit 200. As a method for calculating the SOC, various well-known algorithms, such as an algorithm using current value integration (Coulomb count) or an algorithm using estimation of open circuit voltage (OCV), can be employed.

The automatic parking execution switch 350, the vehicle speed sensor 352, the shift position sensor 354, the hydraulic brake pressure sensor 356 and a camera 358 are connected to the ECU 300.

The automatic parking execution switch 350 may be, for example, a button or a lever. In a case where the automatic parking execution switch 350 receives an ON operation (for example, an operation of pressing the button or an operation of moving the lever to a predetermined position) performed by the user, the automatic parking execution switch 350 is configured to transmit, to the ECU 300, a signal indicating that the ON operation is received.

The vehicle speed sensor 352 detects the speed of the vehicle 1 (hereinafter referred to as “vehicle speed”). The vehicle speed sensor 352 transmits a signal indicating the detected vehicle speed to the ECU 300.

The shift position sensor 354 detects a gear shift position selected by the user from a plurality of gear shift positions. The plurality of gear shift positions may include, for example, a parking position, a reverse position (hereinafter referred to as a “R position”), a neutral position, and a drive position (hereinafter referred to as a “D position”). The shift position sensor 354 transmits a signal indicating the detected gear shift position to the ECU 300.

For example, in a case where the D position is set as the gear shift position, the ECU 300 controls each device (for example, the PCU 40 and the engine 14) in the vehicle 1 such that the vehicle 1 can move forward.

Similarly, for example, in a case where the R position is set as the gear shift position, the ECU 300 controls each device (for example, the PCU 40 and the engine 14) in the vehicle 1 such that the vehicle 1 can move backward.

Further, the ECU 300 controls the PCU 40 so as to generate the driving torque equivalent to creep torque in the second MG 12 in a case where a traveling position, such as the D position or the R position, is selected and the vehicle speed is equal to or less than a threshold, even in a state where an accelerator pedal is not depressed.

The hydraulic brake pressure sensor 356 detects the hydraulic pressure supplied to the braking device 31 (hereinafter referred to as a “hydraulic brake pressure”). The hydraulic brake pressure sensor 356 transmits a signal indicating the detected hydraulic brake pressure to the ECU 300.

The cameras 358 are provided, for example, on a front side and a rear side of the vehicle 1, and are configured to be able to capture image of the front and the rear of the vehicle 1. The camera 358 transmits a signal indicating a captured image to the ECU 300.

In the vehicle 1 having such a configuration, in a case where the accelerator pedal and the brake pedal are depressed in parallel while the vehicle 1 is stopped, the electric power is supplied to the second MG while the rotation of the drive wheel 28 is limited. Therefore, the second MG 12 may become overheated. Thus the ECU 300 executes torque limit control for setting an upper limit value of the driving torque generated in the second MG 12 in a case where a predetermined execution condition is satisfied.

Examples of the predetermined execution condition include, for example, a condition in which the vehicle 1 is stopped, a condition in which the vehicle 1 is in a brake-on state where the hydraulic brake pressure is greater than a threshold, and a condition in which the gear shift position is a traveling position (D position or R position).

The upper limit value of the driving torque of the second MG 12 is set, for example, such that the motor is not overheated even if a predetermined time elapses in a case where current flows through the second MG 12 in a state where the rotation of the drive wheel 28 is limited.

It is possible to prevent the second MG 12 from being overheated in a case where, for example, the accelerator pedal and the brake pedal are depressed in parallel by the user while the vehicle 1 is stopped, by executing the torque limit control in a case where the predetermined execution condition is satisfied.

Further, in a case where the ON operation is performed on the automatic parking execution switch 350 while the vehicle 1 is stopped, the automatic parking control is executed to move the vehicle 1 toward the target location without the operation of the user. The operation including at least one of a driving operation, a braking operation, a steering operation, and a shifting operation, which is required until the vehicle 1 is parked in a parking space, is automatically performed by executing the automatic parking control.

For example, when the user turns on the automatic parking execution switch 350 in a state where the vehicle is stopped next to an entrance of the parking space surrounded by a boundary line, a predetermined parking operation is performed such that the vehicle 1 is parked in the parking space.

The predetermined parking operation may include, for example, a first operation and a second operation. The first operation includes the steering operation in which the vehicle is steered in a first direction away from the parking space when the vehicle is moving forward, the driving operation in which the vehicle 1 moved forward by a predetermined distance in a state where the D position is selected, and the braking operation in which the vehicle 1 is stopped. The second operation, after the first operation is completed, includes the steering operation in which the vehicle is steered in a second direction opposite to the first direction, the operation in which the gear shift position is shifted from the D position to the R position, the driving operation in which the vehicle 1 is moved backward so as to enter the parking space in a state where the R position is selected, and the braking operation in which the vehicle 1 is stopped.

The boundary line set as the parking space may be recognized by, for example, image processing executed on the image captured by the camera 358, and various operations (the driving operation, the braking operation, or the steering operation) are performed such that the vehicle 1 enters the parking space based on the recognition result.

It is possible to move the vehicle 1 to the parking space without the operation of the user by executing the automatic parking control as described above.

When the vehicle 1 is stopped while the automatic parking control is executed, the vehicle 1 is in the brake-on state in which the hydraulic brake pressure is higher than the threshold such that the vehicle 1 does not move due to the driving torque which is equivalent to the creep torque. In a case where the vehicle 1 is started while the automatic parking control is executed, the brake actuator 29 is required to be controlled such that the hydraulic brake pressure gradually decreases as the driving torque increases in order to prevent the vehicle 1 from falling backward in a parking lot including a slope.

However, when the vehicle 1 is in the brake-on state in which the hydraulic brake pressure is greater than the threshold in a case where the driving torque of the second MG 12 is applied to the vehicle 1 that has stopped, the upper limit value is set for the driving torque of the second MG 12 by the torque limit control described above. Therefore, since the driving torque for starting the vehicle 1 in the parking lot including a slope is insufficient, the vehicle 1 may fall backward or it may take a longer time to complete the predetermined parking operation due to a decreased moving speed.

In the present embodiment, the ECU 300 cancels, while executing the automatic parking control, the limitation of the driving torque in a case where the driving torque is applied to the vehicle 1 that has stopped.

Consequently, it is possible to prevent the vehicle from falling backward due to insufficient driving torque during the automatic parking control on the slope. Therefore, the parking can be promptly completed by the predetermined parking operation.

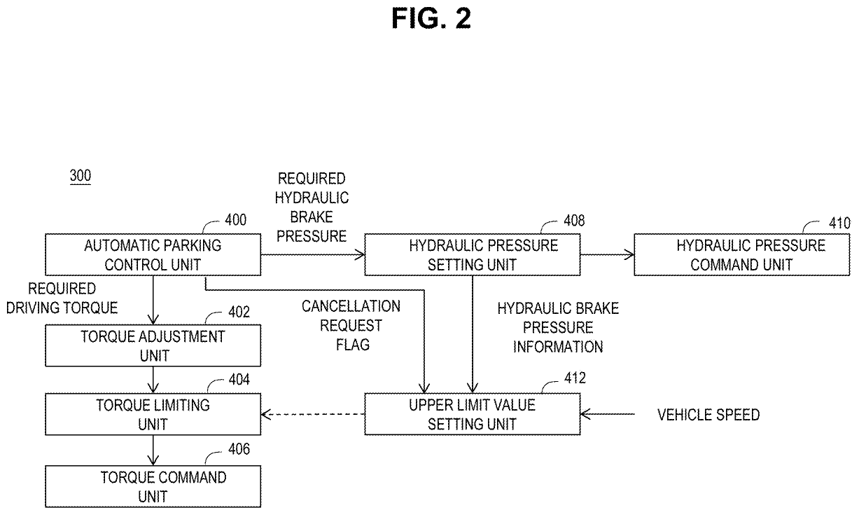

A part of a configuration of functional blocks set in the ECU 300 as software or hardware and the operation thereof will be described hereinbelow with reference to FIG. 2. FIG. 2 is a diagram showing a part of the functional blocks set in an ECU 300.

The ECU 300 includes an automatic parking control unit 400, a torque adjustment unit 402, a torque limiting unit 404, a torque command unit 406, a hydraulic pressure setting unit 408, a hydraulic pressure command unit 410, and an upper limit value setting unit 412.

The automatic parking control unit 400 may execute, for example, the automatic parking control that performs the predetermined parking operation when the ON operation of the automatic parking execution switch 350 is received. The automatic parking control unit 400 sets, while executing the automatic parking control, various required amounts for performing various operations (the driving operation, the braking operation, the steering operation, and the shifting operation) that constitute the predetermined parking operation. The various required amounts may include, for example, a required driving torque and a required hydraulic brake pressure. The automatic parking control unit 400 may set, for example, the required driving torque such that the driving torque of the second MG 12 gradually increases until the vehicle speed reaches a target vehicle speed when the vehicle 1 is started. Furthermore, the automatic parking control unit 400 may set, for example, the required hydraulic brake pressure such that the hydraulic brake pressure gradually decreases when the vehicle 1 is started.

The various required amounts may include, for example, a required steering force. The automatic parking control unit 400 sets the required steering force such that the steering wheel is steered in a steering direction based on the predetermined parking operation (steering operation). A steering control unit (not shown in FIG. 2) controls the EPS 360 such that the set required steering force is generated.

Furthermore, the automatic parking control unit 400 may set a forward drive request or a backward drive request based on the predetermined parking operation. The gear shift control unit (not shown in FIG. 2) selects the D position as the required gear shift position when the forward drive request is set, and selects the R position as the required gear shift position when the backward drive request is set. Switching to the required gear shift position may be automatically performed using an actuator or the like, or may be performed by prompting the switching by offering a display guidance or a voice guidance to the driver.

Further, the automatic parking control unit 400 turns on a cancellation request flag for canceling the limitation of the driving torque in a case where a request to start the vehicle 1 is issued for performing the driving operation. The automatic parking control unit 400 turns off the cancellation request flag in a case where the predetermined period has elapsed from the time when the cancellation request flag was turned on. The automatic parking control unit 400 determines that there is a request to start the vehicle 1 in a case where, for example, the vehicle speed is zero and the required driving torque is greater than a threshold.

The torque adjustment unit 402 adjusts a plurality of pieces of required driving torque set in a plurality of functional blocks including the automatic parking control unit 400 to set a single piece of required driving torque. The torque adjustment unit 402 sets, for example, the greatest required driving torque from among various pieces of required driving torque as the required driving torque after adjustment. Further, the adjustment is not limited to the method described above, and the torque adjustment unit 402 may set, for example, a required driving torque set in the functional block having a high priority as the required driving torque after adjustment.

The torque limiting unit 404 compares the required driving torque after adjustment with the upper limit value of the driving torque calculated by the upper limit value setting unit 412, to be described below, so as to set the final value of required driving torque. The torque limiting unit 404 sets the upper limit value as the final value of required driving torque in a case where, for example, the required driving torque after adjustment exceeds the upper limit value. The torque limiting unit 404 sets the required driving torque after adjustment as the final value of required driving torque in a case where the required drive torque after adjustment is equal to or less than the upper limit value.

The torque command unit 406 generates a control command for generating the final value of required driving torque set in the torque limiting unit 404, and transmits the generated control command to the PCU 40.

The hydraulic pressure setting unit 408 acquires a current hydraulic brake pressure from the hydraulic brake pressure sensor 356. The hydraulic pressure setting unit 408 sets the final value of required hydraulic brake pressure using the required hydraulic brake pressure set by the automatic parking control unit 400, and the acquired current hydraulic brake pressure. The hydraulic pressure setting unit 408 may set the final value of required hydraulic brake pressure, for example, such that the current hydraulic brake pressure gradually approaches the required hydraulic brake pressure.

The hydraulic pressure command unit 410 generates a control command for generating the required hydraulic brake pressure set in the hydraulic pressure setting unit 408, and transmits the generated control command to the brake actuator 29.

The upper limit value setting unit 412 sets the upper limit value for preventing the second MG 12 from being overheated in a case where, for example, a predetermined condition is satisfied. Examples of the predetermined condition include a condition in which the cancellation request flag is in an OFF state, in addition to the predetermined execution condition of the torque limit control described above. The upper limit value may be a predetermined value, or may be set based on, for example, a temperature or a load history of the second MG 12. The upper limit value setting unit 412 cancels setting of the upper limit value in a case where, for example, the predetermined condition is not satisfied. In this case, the upper limit value setting unit 412 sets, for example, an upper limit value that is greater than the upper limit value set as the predetermined condition is established (for example, greater than the required driving torque that can be set in the automatic parking control unit 400).

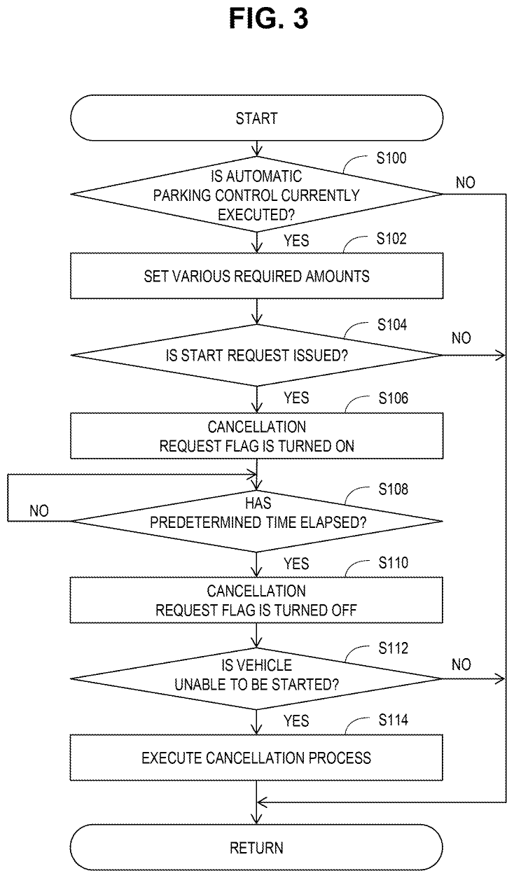

One example of processing executed by the automatic parking control unit 400 will be described hereinbelow with reference to FIG. 3. FIG. 3 is a flowchart showing one example of the processing executed by the automatic parking control unit 400.

In step (hereinafter step is simply referred to as “S”) 100, the automatic parking control unit 400 determines whether the automatic parking control is currently being executed.

The automatic parking control unit 400 sets an automatic parking control execution flag to the ON state by, for example, performing the ON operation of the automatic parking execution switch 350. Therefore, the automatic parking control unit 400 determines that the automatic parking control is currently being executed in a case where the automatic parking control execution flag is in the ON state. Further, the automatic parking control unit 400 sets the automatic parking control execution flag to the OFF state in a case where the automatic parking control is completed or interrupted. In a case where it is determined that the automatic parking control is currently being executed (YES in S100), the process proceeds to S102.

In S102, the automatic parking control unit 400 sets the various required amounts. Since the various required amounts are as described above, the detailed descriptions thereof will be omitted.

In S104, the automatic parking control unit 400 determines whether a start request is issued for the vehicle 1. Since the method for determining whether the start request is issued is as described above, the detailed descriptions thereof will be omitted. In a case where it is determined that the start request is issued (YES in S104), the process proceeds to S106.

In S106, the automatic parking control unit 400 sets the cancellation request flag to the ON state. At this time, the automatic parking control unit 400 measures, for example, the elapsed time from the time when the cancellation request flag is set to the ON state using a timer (not shown) or the like.

In S108, the automatic parking control unit 400 determines whether a predetermined time has elapsed from the time when the cancellation request flag was set to the ON state. In a case where it is determined that the predetermined time has elapsed (YES in S108), the process proceeds to S110.

In S110, the automatic parking control unit 400 sets the cancellation request flag to the OFF state. In S112, the automatic parking control unit 400 determines whether the vehicle 1 is unable to be started. The automatic parking control unit 400 determines that the vehicle 1 is unable to be started in a case where, for example, the vehicle speed is less than or equal to the threshold. In a case where it is determined that the vehicle 1 is unable to be started (YES in S112), the process proceeds to S114.

In S114, the automatic parking control unit 400 executes a cancellation process of canceling the starting of the vehicle 1. In particular, the automatic parking control unit 400 sets, while executing the cancellation process, the required driving torque such that the required driving torque gradually decreases until the required driving torque is equal to or less than a first upper limit value. The automatic parking control unit 400 may set the required driving torque such that, for example, the required driving torque gradually decreases to zero. Further, the automatic parking control unit 400 sets the required driving torque such that, for example, the driving torque linearly decreases (by a predetermined amount).

Further, the automatic parking control unit 400 sets, while executing the cancellation process, the required hydraulic brake pressure such that the required hydraulic brake pressure gradually increases until the required hydraulic brake pressure becomes a target hydraulic brake pressure. The target hydraulic brake pressure may be, for example, the hydraulic brake pressure at the time when the hydraulic brake pressure starts to be reduced in order to start the vehicle 1. The automatic parking control unit 400 sets the required hydraulic brake pressure such that, for example, the hydraulic brake pressure linearly increases (by a predetermined amount). The automatic parking control unit 400 ends the cancellation process in a case where the required driving torque has a value equivalent to the creep torque, and the required hydraulic brake pressure reaches the target hydraulic brake pressure.

In addition, in a case where it is determined that the automatic parking control is not currently being executed (NO in S100), where it is determined that no start request is issued (NO in S104), or where it is determined that the vehicle has started (NO in S112), the process ends. In a case where it is determined that the predetermined time has not elapsed (NO in S108), the process returns to S108.

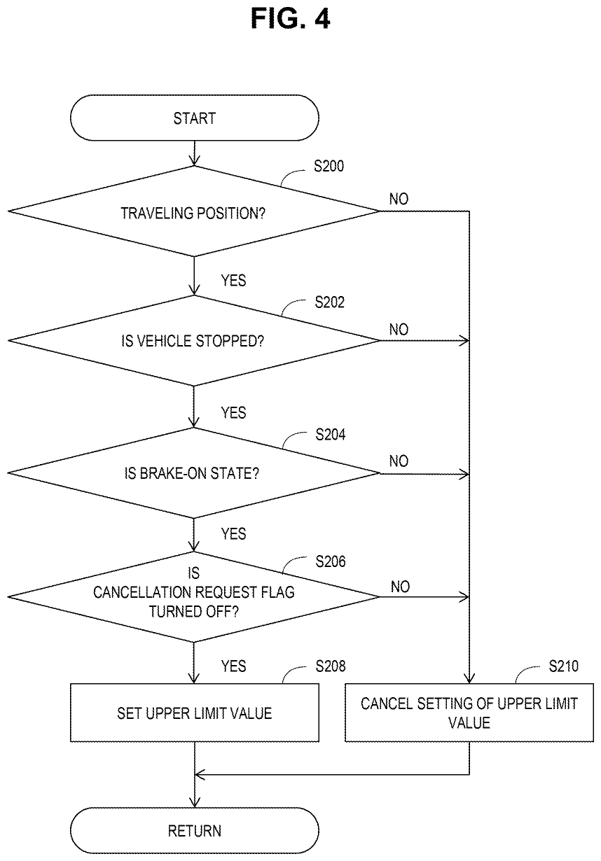

One example of processing executed by the upper limit value setting unit 412 will be described hereinbelow with reference to FIG. 4. FIG. 4 is a flowchart showing one example of the processing executed by the upper limit value setting unit 412.

In S200, the upper limit value setting unit 412 determines whether the gear shift position is a traveling position. The upper limit value setting unit 412 determines that the gear shift position is the traveling position in a case where, for example, the gear shift position is the D position or the R position. In a case where it is determined that the gear shift position is the traveling position (YES in S200), the process proceeds to S202.

In S202, the upper limit value setting unit 412 determines whether the vehicle 1 is stopped. The upper limit value setting unit 412 determines that the vehicle 1 is stopped in a case where the vehicle speed is equal to or less than the threshold. In a case where it is determined that the vehicle 1 is stopped (YES in S202), the process proceeds to S204.

In S204, the upper limit value setting unit 412 determines whether the vehicle is in the brake-on state. The upper limit value setting unit 412 determines that the vehicle is the brake-on state in a case where the current hydraulic brake pressure is higher than a threshold. In a case where it is determined that the vehicle is in the brake-on state (YES in S204), the process proceeds to S206.

In S206, the upper limit value setting unit 412 determines whether the cancellation request flag is in the OFF state. In a case where it is determined that the cancellation request flag is in the OFF state (YES in S206), the process proceeds to S208.

In S208, the upper limit value setting unit 412 sets the upper limit value of the driving torque of the second MG 12. Further, when the gear shift position is not the traveling position (NO in S200), when the vehicle is not stopped (NO in S202), when the vehicle is not in the brake-on state (NO in S204), or when the cancellation request flag is in the ON state (NO in S206), the process proceeds to S210.

In S210, the upper limit value setting unit 412 cancels setting of the upper limit. The upper limit value setting unit 412 may set, as a new upper limit value, a value greater than the required driving torque that can be set in the automatic parking control unit 400.

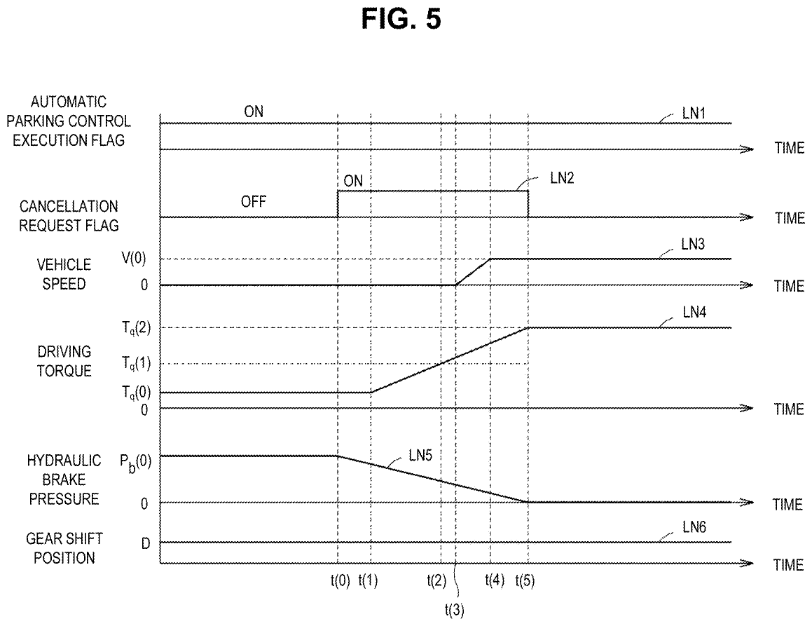

One example of the operation of the ECU 300 mounted on the vehicle 1, which is the electric vehicle according to the present embodiment, based on the structures and flowcharts described above, will be described hereinbelow. FIG. 5 is a timing chart showing one example of the operation of the ECU 300. A horizontal axis in FIG. 5 indicates time. A vertical axis in FIG. 5 indicates the automatic parking control execution flag, the cancellation request flag, the vehicle speed, the driving torque, the hydraulic brake pressure, and the gear shift position.

LN1 in FIG. 5 indicates a change in the automatic parking control execution flag. LN2 in FIG. 5 indicates a change in the cancellation request flag. LN3 in FIG. 5 indicates a change in the vehicle speed. LN4 in FIG. 5 indicates a change in the driving torque. LN5 in FIG. 5 indicates a change in the hydraulic brake pressure. LN6 in FIG. 5 indicates a change in the gear shift position.

For example, it is assumed that the automatic parking execution switch 350 is turned on and the automatic parking control is currently being executed. In this case, the automatic parking control execution flag is maintained as being in the ON state as indicated by LN1 in FIG. 5. Further, it is assumed that the vehicle speed is zero (the vehicle is stopped) as shown by LN3 in FIG. 5, the driving torque is Tq(0) equivalent to the creep torque as shown by LN4 in FIG. 5, and the hydraulic brake pressure is Pb(0) (in a constant state) as shown by LN5 in FIG. 5. Further, as shown by LN6 in FIG. 5, the gear shift position is assumed to be the D position. The drive operation shown in FIG. 5 is assumed to be performed as, for example, the driving operation included in the first operation of the predetermined parking operation.

At this time, the gear shift position is the D position which is the traveling position as shown by LN6 in FIG. 5 (YES in S200), the vehicle is stopped as shown by LN3 in FIG. 5 (YES in S202), the vehicle is in the brake-on state as shown by LN5 in FIG. 5 (YES in S204), and the cancellation request flag is in the OFF state as shown by LN2 in FIG. 5 (YES in S206), thus an upper limit value Tq(1) of the driving torque of the second MG 12 is set (S208).

At time t(0), while the automatic parking control is executed (YES in S100), if various required amounts are set to perform the driving operation (S102), the start request is issued (YES in S104), thus the cancellation request flag is set to the ON state (S106). Since the cancellation request flag is in the ON state (NO in S206), setting of the upper limit value Tq(1) of the driving torque of the second MG 12 is canceled (S210).

Since the required hydraulic brake pressure is set to gradually decrease while setting the various required amounts, the hydraulic brake pressure decreases by a predetermined amount over time as shown by LN5 in FIG. 5, from the hydraulic brake pressure Pb(0) to zero at time t(5).

Further, while setting the various required amounts, the required driving torque is set to gradually increase until the vehicle speed reaches the target vehicle speed. Therefore, the driving torque increases by a predetermined amount over time when the driving torque starts to increase at time t(1) after time t(0). Further, a timing at which the driving torque starts to increase may be the same as a timing at which the hydraulic brake pressure starts to decrease, or may be earlier than the timing at which the hydraulic brake pressure starts to decrease, and the timing can be appropriately set.

The setting of the upper limit value of the driving torque of the second MG 12 is canceled, thus the driving torque continuously increases even after the driving torque reaches the upper limit value Tq(1) at time t(2), as shown by LN4 in FIG. 5.

When the driving force acting on the vehicle 1 exceeds the force that limits the movement of the vehicle 1 due to the increased driving torque of the second MG 12 at time t(3), the vehicle 1 starts to move. Therefore the vehicle speed increases as shown by LN3 in FIG. 5.

The vehicle speed becomes constant at time t(4) as shown by LN3 in FIG. 5. When it reaches time t(5) as the predetermined time has elapsed from time t(0) (YES in S108), the cancellation request flag is in the OFF state as shown by LN2 in FIG. 5 (S110). If the vehicle 1 has started to move, it is determined that the vehicle can be started (NO in S112), and therefore the cancellation process is not executed.

Further, at time t(5) when the cancellation request flag is in the OFF state, when the driving torque of the second MG 12 reaches Tq(2) as shown by LN4 in FIG. 5, in a case where the vehicle speed reaches the target vehicle speed, the driving torque is maintained so as to be constant thereafter. Further, as shown by LN5 in FIG. 5, when the hydraulic brake pressure reaches zero, the hydraulic brake pressure is continuously maintained so as to be constant thereafter. The second operation is performed after the other operations included in the first operation are performed as well as the driving operation.

When the second operation is performed and the vehicle 1 is moved backward by switching from the D position to the R position, the same operation as the driving operation described above is performed. That is, setting of the upper limit value of the driving torque of the second MG 12 is canceled as the cancellation request flag is in the ON state.

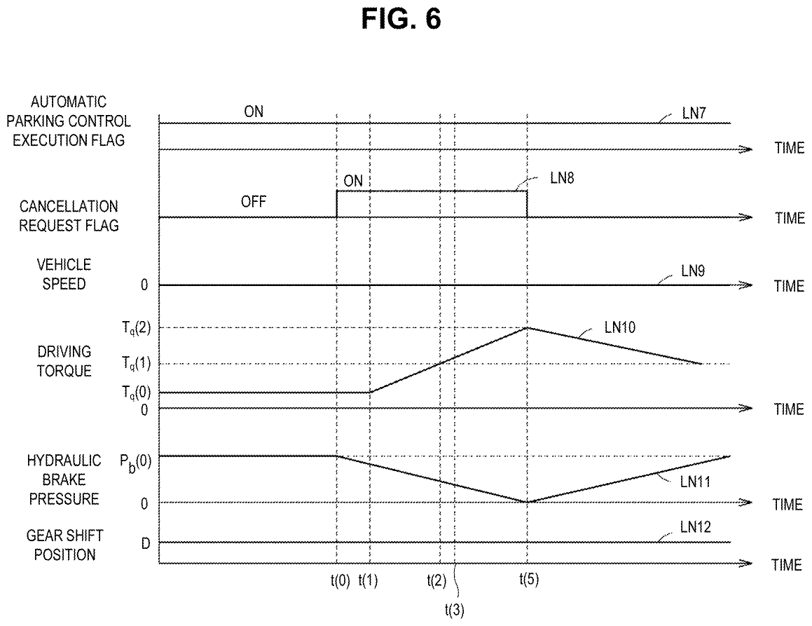

Another example of the operation of the ECU 300 mounted on the vehicle 1, which is the electric vehicle according to the present embodiment, will be described hereinbelow. FIG. 6 is a timing chart showing another example of the operation of the ECU 300. A horizontal axis in FIG. 6 indicates time. A vertical axis in FIG. 6 is the same as the vertical axis in FIG. 5. Therefore, the detailed descriptions thereof will be omitted.

LN7 in FIG. 6 indicates a change in the automatic parking control execution flag. LN8 in FIG. 6 indicates a change in the cancellation request flag. LN9 in FIG. 6 indicates a change in the vehicle speed. LN10 in FIG. 6 indicates a change in the driving torque. LN11 in FIG. 6 indicates a change in the hydraulic brake pressure. LN12 in FIG. 6 indicates a change in the gear shift position.

The changes shown by LN7, LN8, LN12 in FIG. 6 are the same as the changes shown by LN1, LN2, LN6 in FIG. 5, respectively. The changes shown by LN9 to LN11 in FIG. 6 up to time t(3) are the same as the changes shown by LN3 to LN5 in FIG. 5 up to time t(3), respectively. Therefore, the detailed descriptions thereof will be omitted.

In a case where, for example, the slope is steep at time t(3), the driving torque of the second MG 12 does not exceed the force that limits the movement of the vehicle 1, and therefore the vehicle 1 does not start to move. Thus, as shown by LN9 in FIG. 6, the vehicle 1 continues to stop after time t(3).

When it reaches time t(5) as the predetermined time has elapsed from time t(0) (YES in S108), the cancellation request flag is in the OFF state as shown by LN8 in FIG. 6 (S110). Since the vehicle 1 does not start to move, it is determined that the vehicle is unable to be started (YES in S112), and therefore the cancellation process is executed (S114).

Therefore, as shown by LN10 in FIG. 6, the driving torque of the second MG 12 gradually decreases after time t(5) so as to be equal to or less than the upper limit value Tq(1). Further, as shown by LN11 in FIG. 6, the hydraulic brake pressure gradually increases after time t(5) until the hydraulic brake pressure reaches Pb(0).

According to the electric vehicle of the present embodiment, while the automatic parking control is executed, the limitation of the driving torque is canceled in a case where the driving torque is applied to the vehicle 1 that has stopped. Thus, it is possible to prevent the vehicle 1 from falling backward due to insufficient driving torque during the automatic parking control on the slope or the like. Therefore, the parking can be promptly completed. Therefore, it is possible to provide an electric vehicle and a control method for an electric vehicle, which are respectively capable of promptly completing parking while preventing the vehicle from falling backward when executing automatic parking control.

Furthermore, while the automatic parking control is executed, the limitation of the driving torque is canceled until the predetermined period elapses in a case where the driving torque is applied to the vehicle 1 that has stopped. Thus, it is possible to prevent the vehicle 1 from falling backward due to insufficient driving torque during the automatic parking control on the slope or the like.

Moreover, it is possible to prevent the vehicle 1 from falling backward by gradually changing the driving torque in a case where the vehicle 1 does not move while the automatic parking control is executed. Further, it is possible to prevent the second MG 12 from being overheated by reducing the driving torque such that the drive torque is equal to or less than the upper limit value.

Further, while the automatic parking control is executed, the driving torque increases and the hydraulic pressure supplied to the braking device 31 is reduced in a case where the driving torque is applied to the vehicle 1 that has stopped. Therefore, it is possible to prevent the vehicle 1 from falling backward on the slope while promptly completing the parking.

Modified examples will be described hereinbelow. In the embodiment described above, the configuration of a hybrid vehicle has been described as the example of the vehicle 1. However, the vehicle 1 is not limited to a hybrid vehicle as long as it is an electric vehicle. The vehicle 1 may be, for example, an electric vehicle equipped with one or more motor generators as a driving source.

Furthermore, in the embodiment described above, the automatic parking control is executed by turning on the automatic parking execution switch. However, instead of turning on the automatic parking execution switch, the automatic parking control may be performed by touch on the automatic parking execution switch displayed on a touchscreen display.

Further, in the embodiment described above, the predetermined parking operation is exemplified in that the vehicle 1 is moved forward while steering in a direction in which the vehicle enters the parking space in a state in which the vehicle is stopped in parallel with the entrance of a parking space that is surrounded by the boundary line, and then the vehicle 1 moves backward with the steering direction reversed, thereby parking in the parking space. However, the parking operation is not particularly limited thereto. For example, the predetermined parking operation may include an operation in which the vehicle is parked in the parking space in a state where the vehicle is parked adjacent to a parking space in which parallel parking is possible, or may include an operation in which the vehicle 1 is moved to the outside of the parking space in a state where the vehicle 1 is stopped in the parking space.

Further, in the embodiment described above, it is exemplified that the driving torque is linearly changed, however, the driving torque may be gradually changed so as to gradually increase or decrease. For example, the driving torque may be changed non-linearly.

Further, in the embodiment described above, it is exemplified that the hydraulic brake pressure is linearly changed, however, the hydraulic brake pressure may be gradually changed so as to gradually increase or decrease. For example, the hydraulic brake pressure may be changed non-linearly.

The modified examples may be implemented by combining all or some of these examples as appropriate. The embodiments disclosed are to be considered as illustrative and not restrictive. The scope of the present disclosure is defined by the terms of the claims, not the description described above, and includes any modifications within the scope and meanings equivalent to the terms of the claims.

What is claimed is:

1. An electric vehicle, comprising:
a power storage device;
a drive electric motor configured to apply driving torque to the electric vehicle using electric power of the power storage device;
a braking device configured to operate by receiving hydraulic pressure; and
a control device configured to limit the driving torque such that the driving torque does not exceed an upper limit value, which is set such that the drive electric motor is not overheated, when the electric vehicle is stopped while the hydraulic pressure is supplied to the braking device,
wherein the control device is configured to, while executing automatic parking control for moving the electric vehicle toward a target location without an operation of a user, cancel the limitation of the driving torque in a case where the driving torque is applied to the electric vehicle that has stopped.

2. The electric vehicle according to claim 1, wherein the control device is configured to, while executing the automatic parking control, cancel the limitation of the driving torque until a predetermined period elapses in a case where the driving torque is applied to the electric vehicle that has stopped.

3. The electric vehicle according to claim 2, wherein the control device is configured to, while executing the automatic parking control, gradually change the driving torque such that the driving torque is equal to or less than the upper limit value in a case where the electric vehicle does not move until the predetermined period elapses.

4. The electric vehicle according to claim 1, wherein the control device is configured to, while executing the automatic parking control, increase the driving torque and reduce the hydraulic pressure supplied to the braking device in a case where the driving torque is applied to the electric vehicle that has stopped.

5. A control method for an electric vehicle, the electric vehicle including a power storage device, a drive electric motor configured to apply driving torque to the electric vehicle using electric power of the power storage device, and a braking device configured to operate by receiving hydraulic pressure, the control method comprising:
limiting the driving torque such that the driving torque does not exceed an upper limit value, which is set such that the drive electric motor is not overheated, when the electric vehicle is stopped while the hydraulic pressure is supplied to the braking device; and
canceling, while executing automatic parking control for moving the electric vehicle toward a target location without an operation of a user, the limitation of the driving torque in a case where the driving torque is applied to the electric vehicle that has stopped.
